(19) United States
(12) Patent Application Publication
(10) Pub. No.: US 2018/0094761 A1
(43) Pub. Date: Apr. 5, 2018

(54) FLUIDIC PIPING SYSTEM FOR AIRCRAFT AND METHOD FOR REPAIRING SAME

(71) Applicant: Airbus Operations SAS, TOULOUSE (FR)

(72) Inventor: Bernard Guering, MONTRABE (FR)

(21) Appl. No.: 15/717,045

(22) Filed: Sep. 27, 2017

(30) Foreign Application Priority Data
Sep. 30, 2016 (FR) 1659442

(51) Int. Cl. F16L 55/16; F16L 59/14; F16L 21/06; B64D 13/06

(52) U.S. Cl. CPC F16L 55/1608; F16L 59/14; B64D 2013/0614; B64D 13/06; F16L 2201/60; F16L 21/06

(57) ABSTRACT

A fluidic piping system for aircraft, comprising a pipe made in a single piece and an insulating sheath surrounding the pipe. The pipe comprises potential cutoff zones defining sections of the fluidic piping system, reinforced zones arranged in pairs on either side of each potential cutoff zone, and non-reinforced zones defined between the pairs of reinforced zones as intermediate zones. An aircraft system, such as a ventilation and air conditioning module for an aircraft avionics bay, can comprise a limited number of such fluidic piping systems, and can easily be repaired by replacing a damaged section of the piping without it being necessary to disassemble the aircraft equipped with such a system.

### CROSS-REFERENCES TO RELATED APPLICATIONS

This application claims the benefit of the French patent application No. 1659442 filed on Sep. 30, 2016, the entire disclosures of which are incorporated herein by way of reference.

### TECHNICAL FIELD

The present invention relates to the field of fluidic piping systems for aircraft, in particular piping systems forming the ventilation and air conditioning modules installed in the avionics bays of aircraft.

It relates more particularly to such a piping system and such a module, and to an assembly method for an aircraft provided with such a module, and a method for repairing such a piping system.

### BACKGROUND OF THE INVENTION

Aircraft usually comprise in their avionics bay, also called “zone E/E bay” or “electric/electronic technical bay,” a ventilation and air conditioning module consisting of an assembly of air piping systems, generally addressed by Chapter 21 of the classification system of the ATA (Air Transport Association of America).

The ventilation and air conditioning modules have consisted until now of a multitude of piping system units, coupled end-to-end. These piping system units are brought one at a time into an aircraft avionics bay, passing through access hatches of relatively small dimensions, then assembled to each other in the avionics bay.

Assembling these units inside the avionics bay is difficult and disadvantageous, in particular in terms of time and assembly costs.

The emergence of modular assembly techniques for aircraft opens the way to a design of the ventilation and air conditioning module in the shape of a single block or a few blocks connected together.

However, repairing such a ventilation and air conditioning module would necessitate disassembling large parts of the aircraft, such as the floor module arranged above the ventilation and air conditioning module, in order to be able to extract the module so as to replace it with another module, which cannot be envisaged in practice.

### SUMMARY OF THE INVENTION

A particular aim of the invention is to provide a simple, affordable and effective solution to this problem.

To that effect, it proposes a fluidic piping system for aircraft, comprising a pipe made in a single piece and of an insulating sheath surrounding the pipe. According to the invention, the pipe comprises potential cutoff zones defining sections of the fluidic piping system, reinforced zones arranged in pairs on either side of each potential cutoff zone, and non-reinforced zones defined between the pairs of reinforced zones as intermediate zones.

The pipe therefore comprises reinforced zones and non-reinforced zones arranged beneath a single insulating sheath, which can be continuous. The terms “reinforced” and “non-reinforced” must be understood as being defined one in relation to the other.

The potential cutoff zones allow sections of the fluidic piping system to be delimited between them. In the event of damage to one of these sections, this can be removed from the fluidic piping system by cutting the two potential cutoff zones that delimit it respectively on either side, then be replaced by a piping system unit of a similar shape.

In this case, the reinforced zones allow the piping system unit to be assembled at the piping system ends formed by the aforementioned cutting of the two potential cutoff zones, by means of a coupling device that can be, in particular, of a conventional type.

The reinforced zones furthermore make it possible to mark, visually or by any other adequate means, the position of each of the potential cutoff zones. This position can therefore be predetermined so as to guarantee the ability to extract the sections of the fluidic piping system from an aircraft by passing them through access hatches of limited dimensions. Furthermore, the prior definition of the sections of the fluidic piping system by means of the potential cutoff zones allows prior knowledge of the geometry of the piping system units that are likely to be needed in order to replace a damaged section.

Each potential cutoff zone preferably has a linear scope, defined in this document as a length along the pipe of the piping system, whether a straight or curved path, comprised between 0.5 cm and 2 cm.

Each intermediate zone preferably has a linear scope greater than 60 cm.

In a preferred embodiment of the invention, the insulating sheath includes visual marks arranged respectively at each of the potential cutoff zones.

Each reinforced zone preferably comprises a thickened annular part of the pipe.

The invention also relates to a ventilation and air conditioning module for an aircraft avionics bay, comprising at least one blower system, an extraction system and an air conditioning system, the module comprising at least one fluidic piping system of the type described above.

The invention also relates to an aircraft, comprising an avionics bay, which houses a ventilation and air conditioning module of the type described above.

The invention also relates to an aircraft assembly method, comprising at least one step comprising putting in place a ventilation and air conditioning module of the type described above in an aircraft avionics bay, and a subsequent step comprising putting in place a floor module above the avionics bay.

The invention, finally, relates to a method for repairing a fluidic piping system of the type described above in an aircraft, comprising the steps:

identifying a damaged section of the fluidic piping system;

determining the two potential cutoff zones delimiting the damaged section;

cutting the pipe of the fluidic piping system at the two potential cutoff zones determined beforehand, so as to separate the damaged section from two ends, thus made, of the fluidic piping system;

removing the damaged section;

supplying a piping system unit of a shape similar to the shape of the damaged section removed at the preceding step;

coupling two opposite ends of the piping system unit to the two ends of the fluidic piping system that were made during the step comprising cutting the pipe.

In the preferred embodiment of the invention, the method furthermore comprises, between the step comprising determining the two potential cutoff zones and the step comprising cutting the pipe, a step comprising removing two portions of the sheath respectively comprising the two visual marks respectively arranged at the two potential cutoff zones delimiting the damaged section.

### BRIEF DESCRIPTION OF THE DRAWINGS

The invention will be better understood, and other details, advantages and characteristics of the invention will emerge on reading the following description given as a non-limitative example and with reference to the attached drawings, in which:

FIG. 1 is a diagrammatic perspective view of a known type of ventilation and air conditioning module for an aircraft avionics bay;

FIG. 2 is a larger scale diagrammatic view of a fluidic piping system belonging to the ventilation and air conditioning module of FIG. 1, illustrating in particular the coupling between two pipes of this piping system;

FIG. 3 is a view similar to FIG. 1, illustrating a ventilation and air conditioning module according to a preferred embodiment of the invention;

FIG. 4 is a larger scale partial diagrammatic view of a fluidic piping system, comprising a pipe and a sheath, and belonging to the ventilation and air conditioning module of FIG. 3;

FIG. 5 is a view similar to FIG. 4, illustrating a visual mark provided in the sheath of the fluidic piping system of FIG. 4;

FIG. 6 is a view similar to FIG. 5, in which the part of the sheath comprising the visual mark has been torn to show a virtual junction zone of the pipe;

FIG. 6A is a diagrammatic half-view in axial cross section of the virtual junction zone of the pipe, corresponding to the part VIA of FIG. 6;

FIGS. 7A-7G are partial diagrammatic views of the fluidic piping system of FIG. 4, illustrating steps of a method for repairing this piping system;

FIGS. 8A-8E are diagrammatic views in axial cross section of a nose of an aircraft, illustrating the steps of an aircraft assembly method.

In all of these figures, identical reference numbers can designate identical or similar units.

### DETAILED DESCRIPTION OF THE PREFERRED EMBODIMENTS

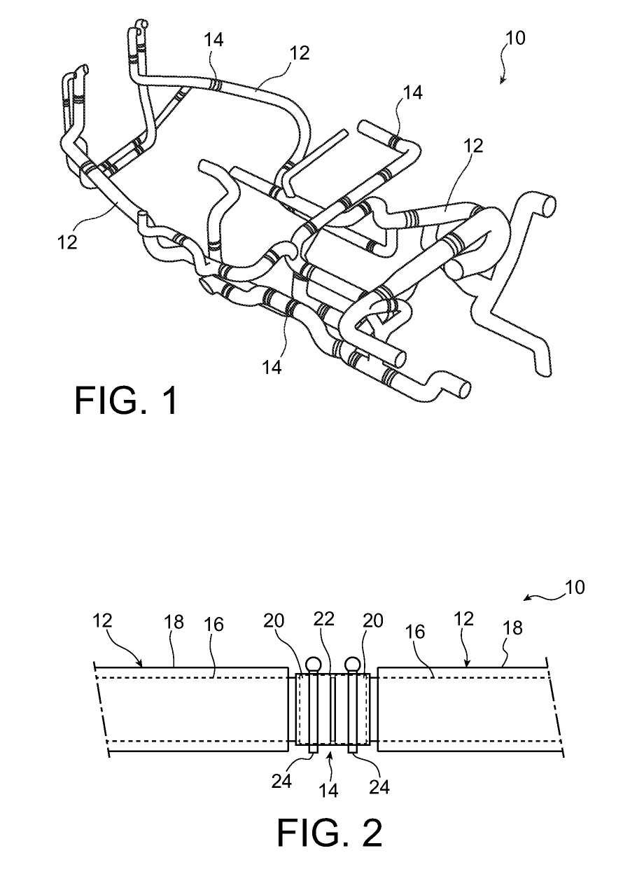

FIG. 1 illustrates a known type of ventilation and air conditioning module 10, intended to be installed in an aircraft avionics bay, and typically comprising a blower system, an extraction system and an air conditioning system, which in principle are doubled to satisfy the redundancy requirements. The function of the blower system is to blow air onto the equipment housed in the avionics bay, the function of the extraction system is to retrieve the air heated on contact with the equipment in order to evacuate it, and the air conditioning system allows the passage of cool air intended for other parts of the aircraft such as the flight deck and passenger cabin.

As shown in FIG. 1, such a module 10 is made from a multitude of piping system units 12, connected together at couplings 14.

FIG. 2 illustrates two piping system units 12, each comprising a pipe 16 surrounded by an insulating sheath 18 providing thermal insulation of the pipe 16. The pipe 16 is made, for example, in glass fiber and phenolic resin, while the insulating sheath 18 is made, for example, in polyurethane foam. At their respective ends, the two pipes 16 have reinforced zones 20, which adopt the shape for example of thickened annular parts. At the coupling 14 between the two piping system units, the two reinforced zones 20 facing each other are inserted together in a sleeve 22 clamped around the two reinforced zones respectively, by means of two pipe clamps 24.

The fragmented structure of the module 10 contributes to making it fragile and makes it obligatory to support the module in multiple places. However, resorting to a large number of units for supporting the module increases the mass of the aircraft and is therefore disadvantageous to its performance. Also, the operations of assembling the numerous units of the piping system 12 are time-consuming and difficult to accomplish inside an aircraft avionics bay.

In order to avoid these disadvantages, the invention proposes a new type of fluidic piping system made in a single piece and provided with potential cutoff zones, as will now be described in greater detail in the context of a particularly advantageous use of this fluidic piping system within a ventilation and air conditioning module. It should be noted that the fluidic piping system according to the invention can also be used in other aircraft systems.

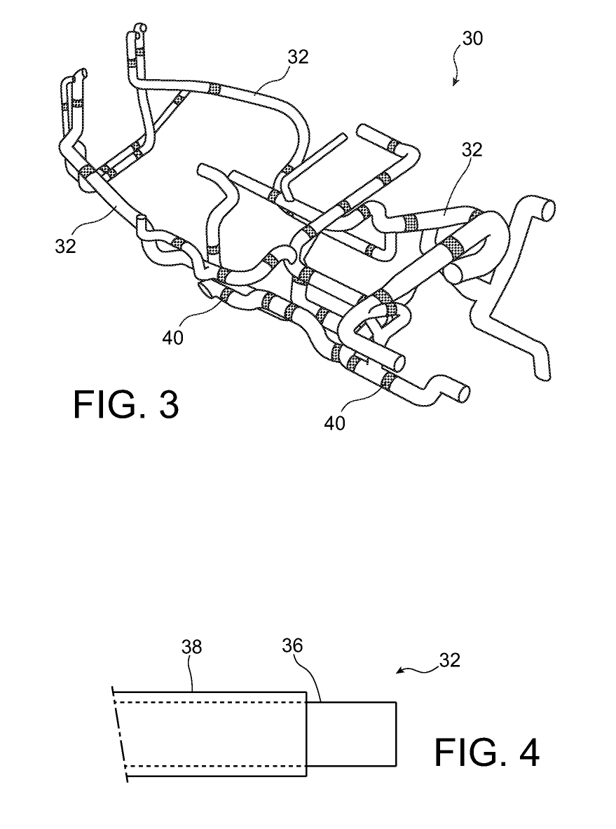

FIG. 3 illustrates a ventilation and air conditioning module 30 comprising a few fluidic piping systems 32 according to a preferred embodiment of the invention. This module has a conformation globally similar to that of the module 10 of FIG. 1, but the module 30 consequently comprises a considerably smaller number of parts.

As illustrated in FIG. 4, each fluidic piping system 32 of the module 30 comprises a pipe 36 made in a single piece, that is to say, continuous from one end to the other of the piping system, and an insulating sheath 38 surrounding the pipe 36 and preferably also made in a single piece.

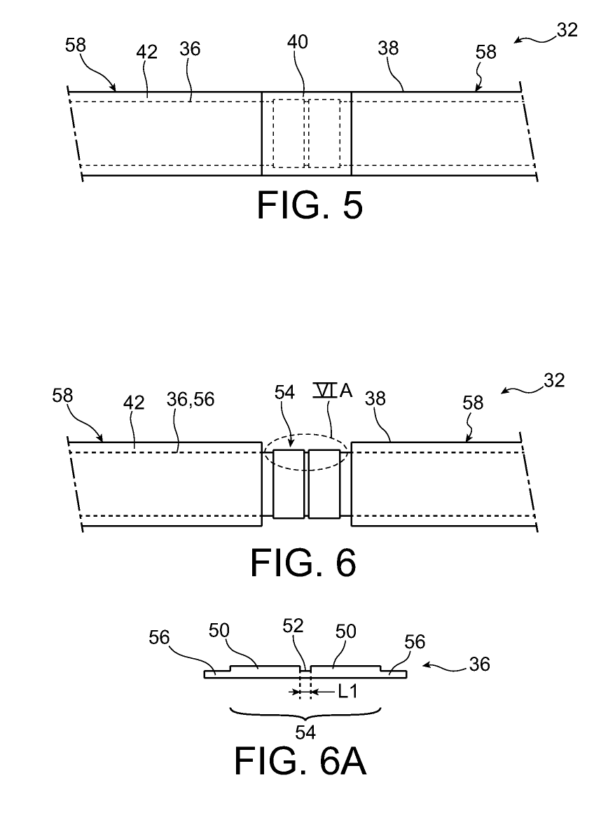

The insulating sheath 38 includes a plurality of marks 40, one of which is visible on FIG. 5. Each of these marks 40 comprises, for example, an annular band of a color different from the color of the remainder 42 of the insulating sheath 38. As will now be described in greater detail, the marks 40 make it possible to identify the position of virtual junction zones including potential cutoff zones defining between them sections of the fluidic piping system 32. These sections are defined so as to guarantee the ability to extract each of the sections through a conventional access hatch of an aircraft avionics bay and the ability to replace the section with a piping system unit of dimensions known beforehand in the event of damage to the section, as will appear more clearly in what is to follow.

FIG. 6 shows the same part of the fluidic piping system 32 as FIG. 5, but the part of the insulating sheath corresponding to the mark 40 of FIG. 5 has been removed so as to allow the pipe 36 to appear. As will appear more clearly on FIG. 6A, the pipe 36 includes, at the mark 40, two reinforced zones 50, each comprising an annular part, thickened and separated from each other by a potential cutoff zone 52, which adopts the shape of a kerf between the two reinforced zones 50. The reinforced zones provide stops close enough together to assist and guide a cutting component such as a thin blade, abrasive wire or another type. When a section of the fluidic piping system is cut, each of its ends has a reinforced zone enabling, as will be seen further on, cooperation with coupling devices. The reinforced zones 50 therefore have a configuration globally similar to the configuration of the respective reinforced zones 20 of the pipes 16 of a known type illustrated on FIG. 2.

In the terminology adopted in the present description, the assembly comprising the two reinforced zones 50 and the potential cutoff zone 52 between them forms a virtual junction zone 54.

It should be noted that the piping system 32 has a plurality of such virtual junction zones 54, arranged respectively at the marks 40 of the insulating sheath 38. These virtual junction zones 54 are separated from each other by non-reinforced zones 56 of the pipe, called “intermediate zones” in the present description. These intermediate zones 56 have a smaller thickness than the thickness of the reinforced zones 50.

The potential cutoff zones 52 between them delimit the aforementioned sections 58 of the fluidic piping system 32.

In the illustrated example, the thickness of the pipe 36 at the intermediate zones 56 is substantially the same as at the potential cutoff zones 52. In other words, the pipe 36 is made in this case from alternating sections 52, 56 having a first thickness, and sections 50 having a second thickness greater than the first thickness.

The linear scope of the intermediate zones 56 is considerably greater than the linear scope of the potential cutoff zones 52. The linear scope of the intermediate zones 56 is therefore several times greater than the linear scope of the potential cutoff zones 52.

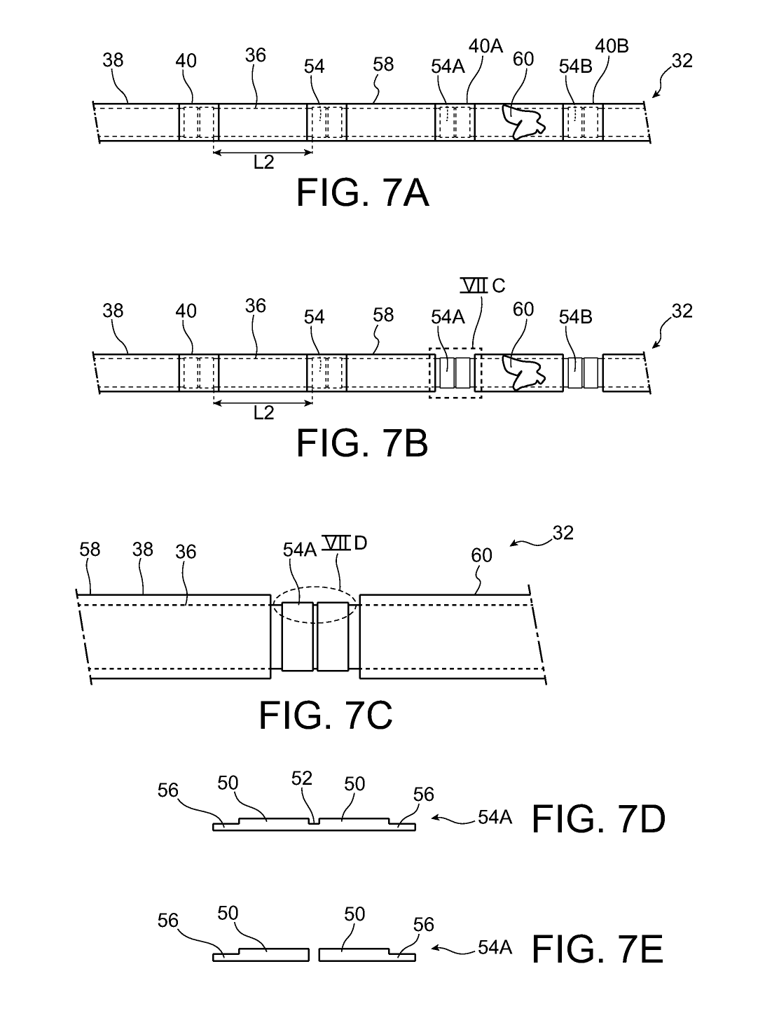

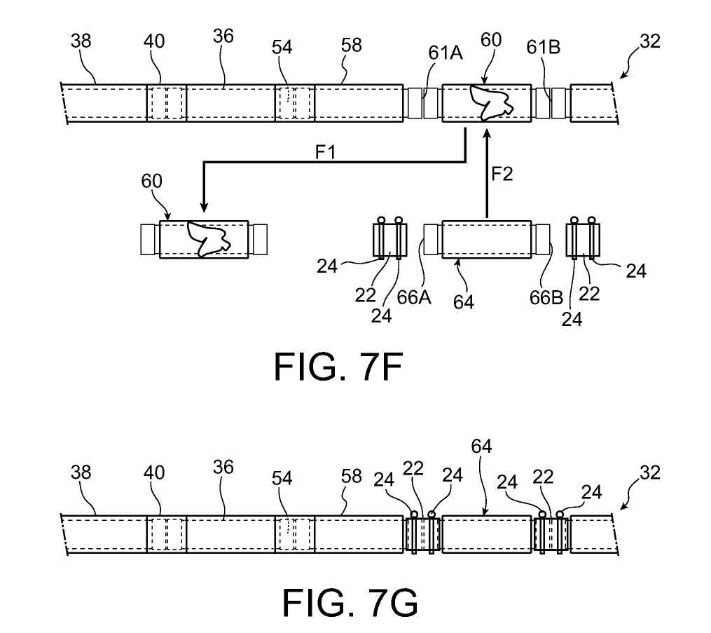

In preferred embodiments of the invention, each potential cutoff zone therefore has a linear scope L1 comprised between 0.5 cm and 2 cm (FIG. 6A). Each intermediate zone furthermore has a linear scope greater than 60 cm (FIG. 7A).

FIGS. 7A-7G illustrate a method for repairing the fluidic piping system 32, taking advantage of its new characteristics.

This repair method comprises a first step comprising identifying a damaged section 60 of the pipe 36 of the fluidic piping system 32 (FIG. 7A).

The repair method then comprises a step comprising determining the two virtual junction zones 54A, 54B, respectively including the two potential cutoff zones 52 that delimit the damaged section 60 (FIG. 7A).

The repair method then includes a step comprising removing the parts of the insulating sheath 38 corresponding to the marks 40A, 40B surrounding the potential cutoff zones 52 belonging to the virtual junction zones 54A, 54B determined at the preceding step (FIG. 7A), so as to leave the fluidic piping system 32 in the condition illustrated on FIG. 7B.

FIG. 7C is a larger scale view of the detail VIIC of FIG. 7B, and FIG. 7D is a larger scale view of the detail VIID of FIG. 7C. These FIGS. 7C and 7D show in particular the virtual junction zone 54A formed by two reinforced zones 50 separated by a potential cutoff zone 52, as described above.

The repair method then includes a step comprising cutting the pipe 36 at the two potential cutoff zones 52 belonging respectively to the two virtual junction zones 54A and 54B determined beforehand, as illustrated in FIG. 7E with regard to the zone 54A.

The damaged section 60 is therefore separated from two ends 61A, 61B of the fluidic piping system, these ends being formed by the cutting operations, as this appears on FIG. 7F.

This FIG. 7F illustrates the continuation of the method, namely:

a step, symbolized by the arrow F1, comprising removing the damaged section 60,

a subsequent step comprising supplying a piping system unit 64 of a shape globally similar to the shape of the damaged section 60 removed at the preceding step,

a subsequent step, symbolized by the arrow F2, comprising coupling two opposite ends 66A, 66B of the piping system unit 64 to the two ends 61A, 61B of the fluidic piping system, these ends being formed by the cutting operations.

The coupling is preferably embodied by means of sleeves 22 and pipe clamps 24, in the same way as described above, with reference to FIG. 2, with regard to coupling the piping system units 12 in the fluidic piping systems of the prior art.

At the end of the repair method, the fluidic piping system 32 thus includes the piping system unit 64 instead and in place of the damaged section 60, as illustrated in FIG. 7G.

As described above, the configuration in the shape of a block of the ventilation and air conditioning module 30 can be used to advantage in a modular type aircraft assembly method.

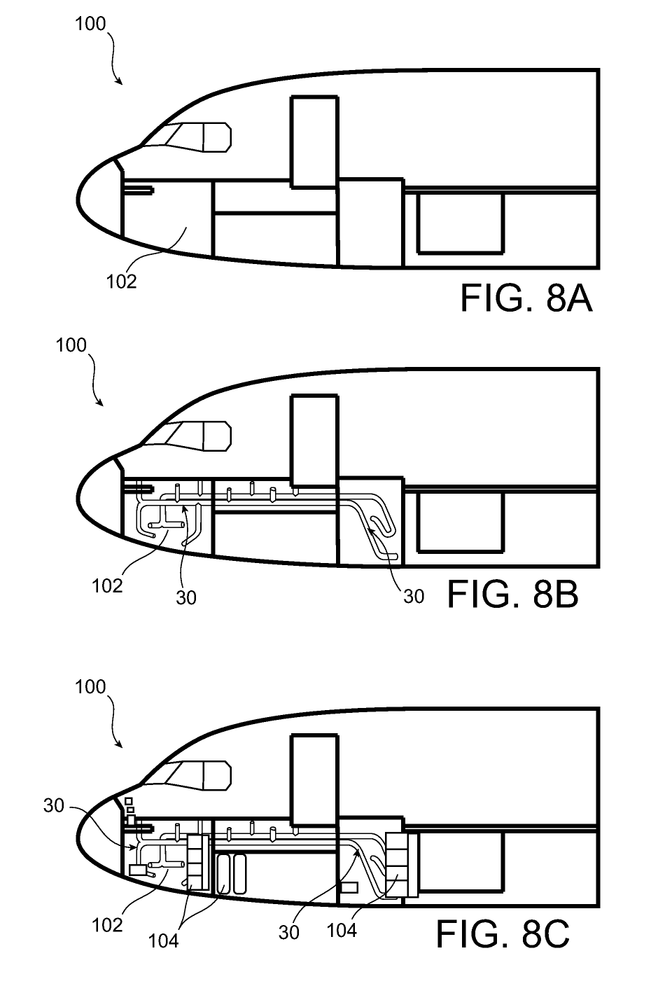

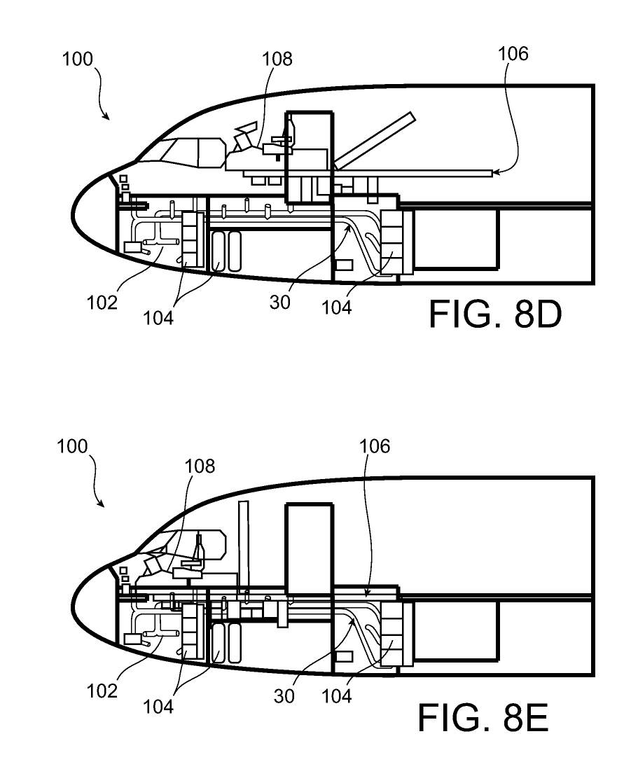

FIGS. 8A-8E illustrate the steps of such a method. From an aircraft nose 100 including an avionics bay 102 (FIG. 8A), the method therefore comprises:

a step comprising putting in place the ventilation and air conditioning module 30 in the avionics bay 102 (FIG. 8B);

a step comprising installing equipment items 104 in the avionics bay 102 (FIG. 8C);

then a step comprising putting in place a floor module 106 above the avionics bay 102, and thus above the ventilation and air conditioning module 30 (FIGS. 8D and 8E).

The floor module 106 is, for example, a module of the type integrating some or all of the equipment and furniture 108 of the flight deck of the aircraft.

Such a method makes it possible to optimize the operations of assembling the aircraft, and, in particular, to avoid the need to assemble a multitude of piping system units inside the avionics bay itself.

If the module 30 is subsequently damaged, the fluidic piping system 32 affected by the damage can then be repaired according to the repair method described above. A damaged section 60 of the fluidic piping system can be extracted from the aircraft and a piping system unit 64 intended to replace the damaged section 60 can be supplied to the avionics bay 102 through conventional access hatches.

It should be noted that the marks 40 can be omitted in certain embodiments of the invention, for example when the insulating sheath 38 is embodied in a transparent material making it possible to identify the position of the potential cutoff zones 52 or the reinforced zones 50 through the insulating sheath.

The reinforced zones 50 can furthermore, as a variant, have a conformation different from that illustrated on the figures, the essential being that these zones are capable of cooperating with coupling devices. The latter can be of the type described above, comprising a sleeve and pipe clamps, or of another type. The reinforced zones 50 are furthermore designed to allow an operator to determine the position of the potential cutoff zones 52.

Finally, it should be noted that the invention can be used to advantage in fluidic piping systems applied to aircraft systems other than the ventilation and air conditioning modules.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fluidic piping system for aircraft, comprising:
a pipe made in a single piece,
an insulating sheath surrounding the pipe,
potential cutoff zones defining sections of the fluidic piping system,
the insulating sheath including visual marks arranged respectively at each of the potential cutoff zones;
reinforced zones arranged in pairs on either side of each potential cutoff zone; and
non-reinforced zones defined between the pairs of reinforced zones as intermediate zones.

2. The fluidic piping system according to claim 1, wherein each potential cutoff zone has a linear scope, being a length along the pipe of the piping system, whether a straight or curved path, comprised between 0.5 cm and 2 cm.

3. The fluidic piping system according to claim 1, wherein each intermediate zone has a linear scope, being a length along the pipe of the piping system, whether a straight or curved path, greater than 60 cm.

4. The fluidic piping system according to claim 1, wherein each reinforced zone comprises a thickened annular part of the pipe.

5. A ventilation and air conditioning module for an aircraft avionics bay, comprising at least one blower system, an extraction system and an air conditioning system, wherein the module comprises at least one fluidic piping system according to claim 1.

6. An aircraft comprising an avionics bay houses a ventilation and air conditioning module according to claim 5.

7. An aircraft assembly method, comprising:
putting in place a ventilation and air conditioning module according to claim 5 in an aircraft avionics bay, and
putting in place a floor module above the avionics bay.

8. A method for repairing a fluidic piping system according to claim 1 in an aircraft, comprising:
identifying a damaged section of the fluidic piping system;
determining the two potential cutoff zones delimiting the damaged section;
cutting the pipe of the fluidic piping system at the two potential cutoff zones determined beforehand, so as to separate the damaged section from two ends, thus made, of the fluidic piping system;
removing the damaged section;
supplying a piping system unit of a shape similar to the shape of the damaged section removed in the preceding step;
coupling two opposite ends of the piping system unit to the two ends of the fluidic piping system that were made during the step comprising cutting the pipe.

9. The method according to claim 8 for repairing a fluidic piping system wherein each reinforced zone comprises a thickened annular part of the pipe, furthermore comprising, between the step comprising determining the two potential cutoff zones and the step comprising cutting the pipe, undertaking a step comprising removing two portions of the sheath respectively comprising the two visual marks respectively arranged at the two potential cutoff zones delimiting the damaged section.
